(19) United States
(12) Patent Application Publication
(10) Pub. No.: US 2006/0200521 A1
(43) Pub. Date: Sep. 7, 2006

(54) FreeFi QwikBar/ToolBar

(75) Inventors: Lawrence J. Laffer, Thousand Oaks, CA (US); Steven M. Russak, Thousand Oaks, CA (US)

Correspondence Address: LAWRENCE J. LAFFER;FREEFI NETWORKS LLC, 2534 RENATA COURT, THOUSAND OAKS, CA, 91362, US

(73) Assignees: Lawrence J. Laffer, Thousand Oaks, CA (US); Steven M. Russak, Thousand Oaks, CA (US)

(21) Appl. No.: 11/164,354

(22) Filed: Nov. 18, 2005

Related U.S. Application Data
(60) Provisional application No. 60/630,276, filed on Nov. 23, 2004.

(51) Int. Cl. G06F 15/16

(52) U.S. Cl. 709/204; 713/182

(57) ABSTRACT

The present invention provides a user access to the Internet via a wireless connection subscribing to the IEEE 802.1 1 or 802.16 standard or their logical derivatives, while being displayed web based content independent of the users web browser. Such content appears when logged in and is removed when logged out of the wireless local area network (WLAN).

### BACKGROUND OF THE INVENTION

The present invention is an Internet portal providing content to a users terminal (wireless-enabled personal computers or other wireless Internet access devices including cellular telephones, personal digital assistants, portable gaming devices) via a publicly available wireless Internet connection and delivered via a local area network (WLAN) and delivered in either graphical or text-based formats.

### BRIEF DESCRIPTION OF THE SEVERAL VIEWS OF THE DRAWINGS

FIG. 1 illustrates the screen display which is shown when a wireless connection is established with the terminal

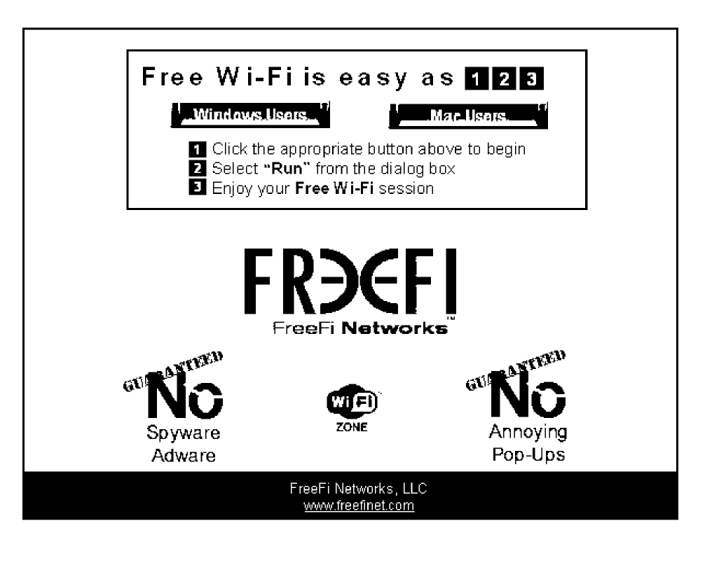

FIG. 2 illustrates the screen display which is shown when the terminal automatically launches a browser and separate content provided by the information provider within the QwikBar.

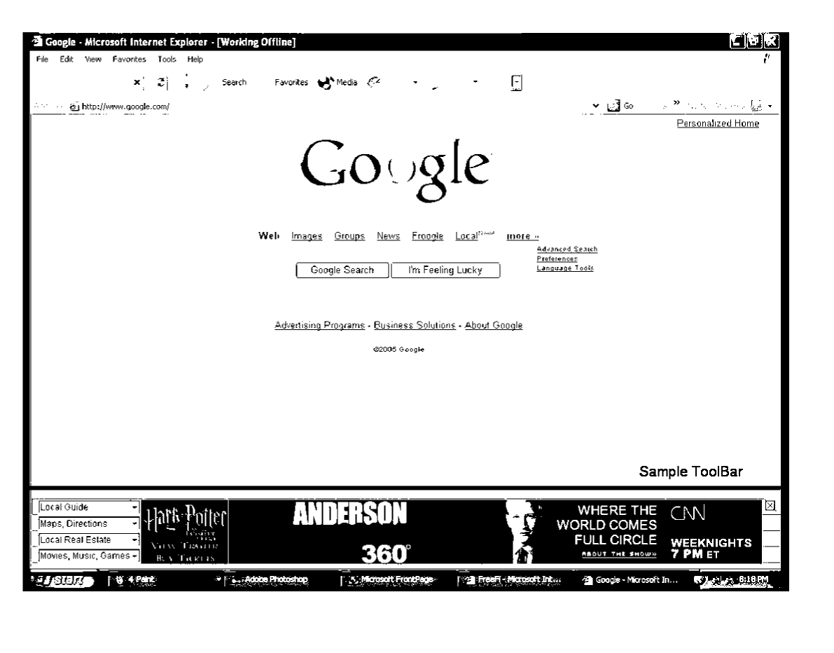

### DETAILED DESCRIPTION OF THE INVENTION

An Internet portal providing content to a users terminal (wireless-enabled personal computers or other wireless Internet access devices including cellular telephones, personal digital assistants, portable gaming devices) via a publicly available wireless Internet connection and delivered via a local area network (WLAN) and delivered in either graphical or text-based formats.

The information provider provides content to the user via a separate Intranet that is enabled when the terminal connected to the WLAN. The content delivered via the Intranet is independent of content delivered to the user via the Internet.

The terminal establishes a wireless connection to the terminal via IEEE 802.11-based protocol or similar protocol commonly referred to as “Wi-Fi” or any such derivatives such as “WiMax”.

The QwikBar/ToolBar portal is automatically displayed on the user's terminal following user log-in and authentication to the WLAN.

The QwikBar/ToolBar portal cannot be moved aside or minimized by the user.

The QwikBar/ToolBar portal is removed from the terminal screen following user log-out of the WLAN.

The QwikBar/ToolBar portal is separate from the users Internet browser window as well as other windows that may be launched on the computer terminal.

The QwikBar/ToolBar portal and its content contained within are served remotely, either over the Internet or over a local area network via locally positioned computer (server) via an Intranet controlled by the information provider.

Some Alternatives:

Although the present invention has been described in conjunction with the specific embodiments, the present invention is not limited to these embodiments. Infinite modifications and substitutions are apparent for those skilled in the art without departing from the spirit and scope of the invention as defined in the claims.

What is claimed is:

1. A communications system comprising an information provider which provides public connections to the World Wide Web via a wireless local area network (WLAN) through a personal computer or handheld device subscribing to the IEEE 802.11 or 802.16 standards, also known as “Wi-Fi” or other derivatives known as “WiMax.” Such device is termed the terminal. The terminal has
A means for establishing a wireless connection from the terminal to the information provider via a wireless local area network wherein,
A means for activating a web browser for displaying a hypertext markup language (HTML) or other such web page provided via the WLAN wherin,
The Information Provider has
A means for activating a browser for displaying a hypertext markup language (HTML) or other such web page provided by the information provider via the WLAN;
A means of transmitting HTML pages or other such online content contained within web pages to the terminal while connected to the public WLAN
A means for authenticating a terminal or terminals to provide access to the Internet acting as a “gateway”;
A means for disconnecting the terminal from the Internet;
A means for displaying information on the terminal separate from the browser which is persistent in nature which as such cannot be removed from the terminal screen until the WLAN connection to the terminal is ended by the terminal user.
